(19) United States
(12) Patent Application Publication
(10) Pub. No.: US 2003/0043111 A1
(43) Pub. Date: Mar. 6, 2003

(54) Portable storage device for presentation

(76) Inventor: Ing-Kai Huang, Taipei (TW)

Correspondence Address: ING-KAI HUANG, P.O. BOX 26-757, TAIPEI, 106, TW

(21) Appl. No.: 09/953,191

(22) Filed: Sep. 6, 2001

(51) Int. Cl. G09G 5/00

(52) U.S. Cl. 345/156

(57) ABSTRACT

A portable storage device for presentation and having laser pointing function comprises a case and a cover assembled on one side of the case. The case contains a storage unit for data storage and a USB interface. The portable storage device has plug-and-play ability to a computer through the USB interface and can send data to the computer. The cover has a laser diode connected to a circuit board within the cover. The cover further has a switch to control the on/off operation of the laser diode. The presentation data in the storage unit can be downloaded to the computer and the cover with laser diode can be operated as a laser pointer.

### FIELD OF THE INVENTION

The present invention relates to a portable storage device for presentation, especially to a portable storage device for presentation, which has functions of plug-and-play and laser pointing.

### BACKGROUND OF THE INVENTION

FIG. 1 is a schematic view showing conventional equipment for presentation. The presentation data is stored in a portable computer unit 1a (such as the notebook computer shown in this figure), or a storage unit. In later case, the portable computer unit 1a reads the presentation data from the storage unit. Afterward, the presentation data is projected from a projector 2a connected to the portable computer unit 1a to a screen 3a. The lecturer can use a laser pointer 4a to point relevant content or topic on the screen 3a.

However, in above-mentioned setup, the lecture often needs to carry the portable computer unit 1a (or the storage unit) and the laser pointer 4a, this is inconvenient.

### SUMMARY OF THE INVENTION

It is an object of the present invention to provide a portable storage device for presentation, whereby the presentation is easily portable and can be transmitted easily to a computer.

It is another object of the present invention to provide a portable storage device for presentation, which has a built-in USB interface to have plug-and-play function.

It is still another object of the present invention to provide a portable storage device for presentation, which is provided with a laser diode for providing laser pointing function.

To achieve above object, the present invention provides a portable storage device for presentation and having laser pointing function. The portable storage device comprises a case and a cover assembled on one side of the case. The case contains a storage unit for data storage and a USB interface. The portable storage device has plug-and-play ability to a computer through the USB interface and can send data to the computer. The cover has a laser diode connected to a circuit board within the cover. The cover further has a switch to control the on/off operation of the laser diode. The presentation data in the storage unit can be downloaded to the computer and the cover with laser diode can be operated as a laser pointer.

The various objects and advantages of the present invention will be more readily understood from the following detailed description when read in conjunction with the appended drawing, in which:

### BRIEF DESCRIPTION OF DRAWINGS

FIG. 1 is a schematic view showing conventional equipment for presentation;

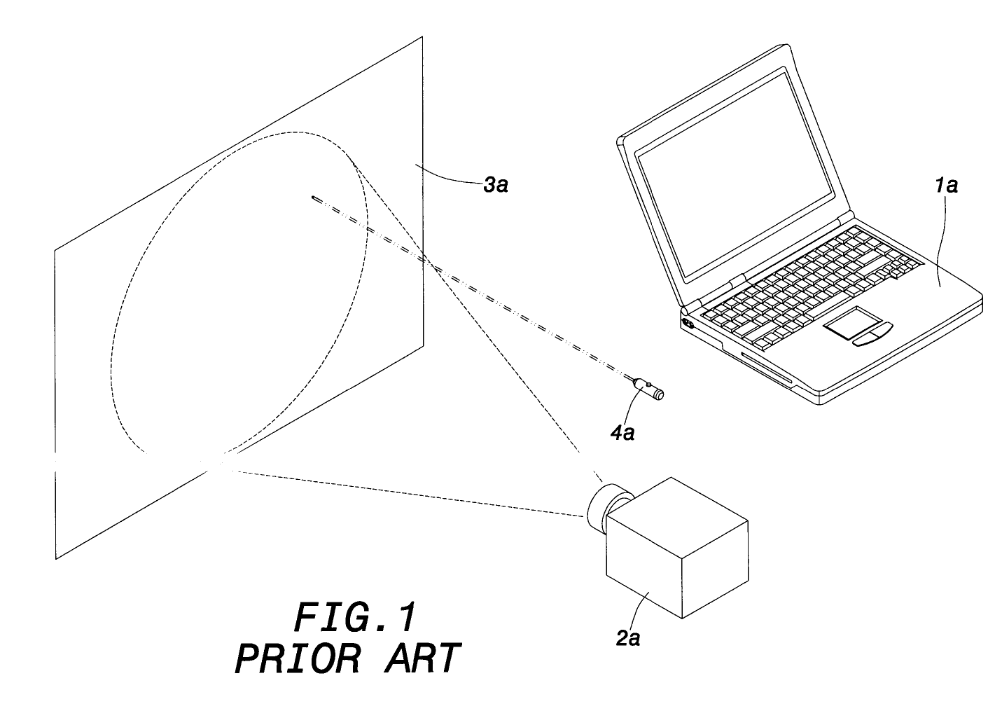

FIG. 2 shows a perspective view of the present invention;

FIG. 3 shows an exploded view of the present invention;

FIG. 4 shows a sectional view of the present invention; and

FIG. 5 is a schematic view showing operation of the present invention.

### DETAILED DESCRIPTION OF THE INVENTION

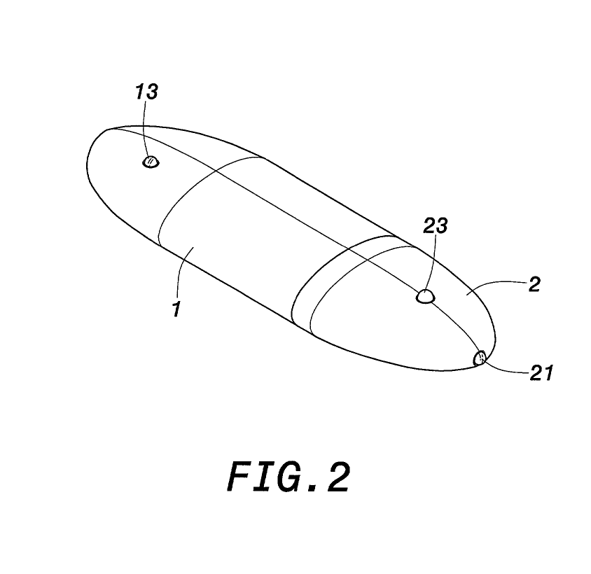

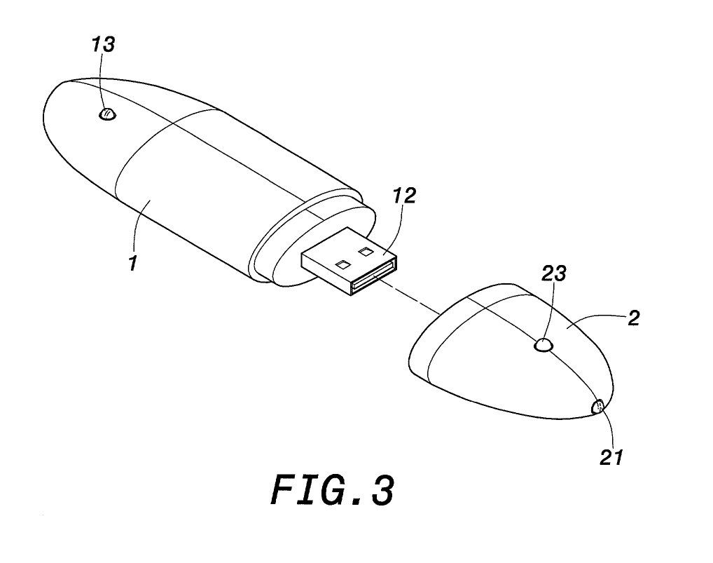

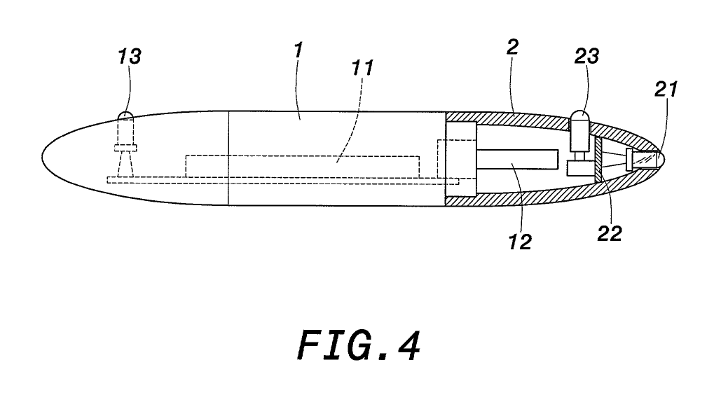

With reference now to FIGS. 2 to 4, the present invention is intended to provide a portable storage device for presentation, which also has laser pointing function. The portable storage device with laser pointing function according to the present invention mainly comprises a case 1 and a cover 2 assembled to one side of the case 1.

The case 1 contains a storage unit 11 such as a flash memory unit for data storage and a USB (universal serial bus) interface 12 on an outer surface thereof. Therefore, the portable storage device has plug-and-play ability to a computer through the USB interface 12. In other word, the data stored in the storage unit 11 of the portable storage device with laser pointing function according to the present invention can be transmitted to the computer and the portable storage device is powered by the computer through the USB interface 12. The case 1 further has an LED (light-emitting diode) 13 on outer surface thereof, and the LED 13 is lighted when the storage unit 11 is accessed.

The cover 2 has a laser diode 21 on top surface thereof and connected to a circuit board 22 within the cover 2. The cover 2 has a switch 23 on a lateral side thereof and connected to the circuit board 22. The switch 23 is used to control the on/off operation of the laser diode 21. When the switch 23 is pressed, the circuit board 22 drives the laser diode 21 to emit laser light.

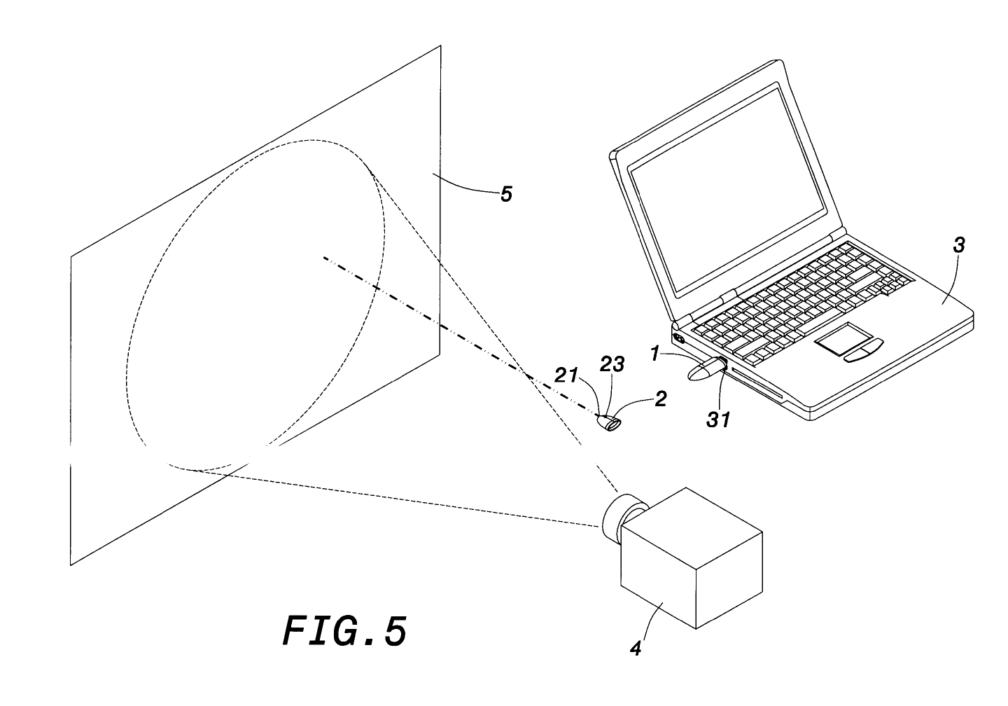

The lecture can store the presentation data in the storage unit 11 within the case 1. As shown in FIG. 5, when the lecture wants to present this data, the cover 2 is removed and the case 1 is connected to a USB port of a notebook computer 3. Therefore, the lecture does not need to carry a notebook computer with him. The presentation data is projected, through a projector 4 connected to the notebook computer 3, to a screen 5. At this time, the lecture can press on the switch 23 on the outer surface of the cover 2 to and the laser diode 21 emits a laser beam as the lecturer point it toward the screen for demonstration.

Moreover, the cover 2 is further provided with a clip to fasten the cover 2 to cloth of the lecture for portability, or the cover 2 is further provided with a clasp for hanging the cover 2.

To sum up, the portable storage device for presentation according to the present invention has following advantages:

1. Plug and play feature and power free.

2. Portability.

3. Laser pointing function.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A portable storage device for presentation and having laser pointing function comprising
a case having a storage unit for data storage and a USB interface through which said portable storage device communicates with a computer; and
a cover assembled on said case, and having a laser diode connected to a circuit board within said cover and a switch connected to said circuit board and used to turn on or turn off said laser diode.

2. The portable storage device as in claim 1, wherein said storage unit is a flash memory.

3. The portable storage device as in claim 1, wherein said cover is provided with a light emitting diode.
